(19) United States
(12) Patent Application Publication
(10) Pub. No.: US 2016/0261517 A1
(43) Pub. Date: Sep. 8, 2016

(54) DEVICE, SESSION PROCESSING QUALITY STABILIZATION SYSTEM, PRIORITY PROCESSING METHOD, TRANSMISSION METHOD, RELAY METHOD, AND PROGRAM

(71) Applicant: NEC CORPORATION, Minato-ku, Tokyo (JP)

(72) Inventors: AKIHITO KOHIGA, Tokyo (JP); TOMOHITO IGUCHI, Tokyo (JP)

(21) Appl. No.: 15/033,698

(22) PCT Filed: Oct. 24, 2014
(86) PCT No.: PCT/JP2014/078365

§ 371 Date: May 2, 2016

(30) Foreign Application Priority Data
Nov. 11, 2013 (JP) 2013-233041

(51) Int. Cl. H04L 12/865; H04L 12/863

(52) U.S. Cl. CPC H04L 47/6275; H04L 47/624; H04L 47/2416

(57) ABSTRACT

A device includes a packet reception unit, a received packet buffer, a priority acquisition unit, and a packet arrangement order adjustment unit.

The packet reception unit is configured to receive a packet. The received packet buffer is configured to store a packet received by the packet reception unit. The priority acquisition unit is configured to obtain a priority of the packet based on transmission source information and destination information included in the packet received by the packet reception unit. The packet arrangement order adjustment unit is configured to change an order of the packets stored in the received packet buffer to an order in accordance with the priority.

### TECHNICAL FIELD

The present invention relates to a device, a session processing quality stabilization system, a priority processing method, a transmission method, a relay method, and a program.

### BACKGROUND ART

A method in which a priority is set to a session in packet communication for maintaining quality of a session having a higher priority by processing packets or the like in accordance with a priority is known.

In addition, regarding such priority setting, PTL 1 discloses a communication network including a plurality of first networks which do not need call control, and a second network which needs call control. The second network has an upper limit for the number of call connections which can be simultaneously established in a communication device, and when call connections are established in an incoming-side device to the upper limit, an error is replied to an origination-side device in response to a call connection request from the origination-side device to the incoming-side device. Further, when it is not transferred to the incoming-side device that the call connection request is issued, the origination-side device transmits a priority incoming call request to the incoming-side device and then transmits a call connection request, and the incoming-side device disconnects an established call in response to the priority incoming call request to reduce the number of call connections to less than the upper limit, and accepts the call connection request from the origination-side device.

PTL 1 describes that, with such an operation, a communication system is obtained which can preferentially establish a new call connection in response to a request from an origination-side device when the number of call connections in the incoming-side device reaches the upper limit.

PTL 2 describes a packet transfer scheme for performing data transfer in the unit of packets, in which a priority right is given to each packet according to urgency, the packet for transmission is divided to perform interruption transmission of a high-priority packet when a transmission request occurs during transmission of a packet for a packet having higher priority than the transmitting packet, and the remaining part of thus divided packet is transmitted after finishing transmission of the high-priority packet.

It is also described that a point at which an interruption against a low-priority packet is allowed, is provided for each constant unit of division, so that an interruption is not allowed at other points.

PTL 2 describes that, with these operations, interruption transmission of a high-priority packet is allowed without deteriorating transmission efficiency in comparison with a conventional scheme when a transmission request for a packet having a higher priority occurs during long packet transmission with low priority, and transmission delay of an urgent packet can be reduced as much as possible.

### CITATION LIST

### Patent Literature

PTL 1: Japanese Laid-open Patent Publication No. 2013-183329

PTL 2: Japanese Laid-open Patent Publication No. S62-114356

### SUMMARY OF INVENTION

### Technical Problem

PTL 1 describes that a priority is obtained from SDPID, but SDP (Session Description Protocol) is added to a body section of a protocol called SIP (Session Initiation Protocol) as an option, and SDP is not always attached to all SIP packets. With respect to a SIP packet to which SDP is not attached, a priority may not be obtained from SDPID.

Further, PTL 1 describes that communication to a particular number is handled as an urgent call, but it is desired to reflect information other than a destination on priority setting in order to enable more flexible priority setting.

PTL 2 describes transmitting a high-priority packet preferentially using a queue for each priority, but how a priority is set is not shown.

An object of the present invention is to provide a device, a session processing quality stabilization system, a priority processing method, a transmission method, a relay method, and a program, which can solve the problems mentioned above.

### Solution to Problem

The present invention is made to solve the problems mentioned above, and a device according to an aspect of the present invention includes: a packet reception unit which receives a packet; a received packet buffer which stores a packet received by the packet reception unit; a priority acquisition unit which obtains a priority of a packet on the basis of transmission source information and destination information included in the packet received by the packet reception unit; and a packet arrangement order adjustment unit which changes an order of the packets stored in the received packet buffer to an order in accordance with the priority.

A device according to another aspect of the present invention includes: a priority-related information storing unit which stores transmission source information and destination information of a first packet in a header of a second packet which stores the first packet; and a packet transmission unit which transmits the second packet which holds transmission source information and destination information of the first packet in the header.

A device according to still another aspect of the present invention includes: a packet transceiver unit which transmits and receives a packet; a priority acquisition unit which obtains a priority of a packet on the basis of transmission source information and destination information included in the packet received by the packet transceiver unit; and a priority setting unit which stores information indicating the priority in a header of the packet, wherein the packet transceiver unit transmits the packet which holds information indicating the priority in the header.

A session processing quality stabilization system according to another aspect of the present invention includes: a transmission-side device which transmits a packet; and a reception-side device which receives the packet, wherein the reception-side device includes: a packet reception unit which receives the packet; a received packet buffer which stores a packet received by the packet reception unit; a priority acquisition unit which obtains a priority of a packet on the basis of transmission source information and destination information included in the packet received by the packet reception unit; and a packet arrangement order adjustment unit which changes an order of the packets stored in the received packet buffer to an order in accordance with the priority.

A session processing quality stabilization system according to still another aspect of the present invention includes: a transmission-side device which transmits a packet; a reception-side device which receives the packet; and a relay device which relays the packet from the transmission-side device to the reception-side device.

The relay device includes: a packet transceiver unit which transmits and receives the packet; a priority acquisition unit which obtains a priority of a packet on the basis of transmission source information and destination information included in the packet received by the packet transceiver unit; and a priority setting unit which stores information indicating the priority in a header of the packet.

The packet transceiver unit transmits the packet which holds information indicating the priority in the header, and the reception-side device includes: a packet reception unit which receives the packet; a received packet buffer which stores a packet received by the packet reception unit; and a packet arrangement order adjustment unit which changes an order of the packets stored in the received packet buffer to an order in accordance with information indicating the priority stored in the header.

A priority processing method according to another aspect of the present invention causes a device including a packet reception unit which receives a packet and a received packet buffer which stores a packet received by the packet reception unit, to execute: a priority acquisition step of obtaining a priority of a packet on the basis of transmission source information and destination information included in the packet received by the packet reception unit; and a packet arrangement order adjustment step of changing an order of the packets stored in the received packet buffer to an order in accordance with the priority.

A transmission method according to another aspect of the present invention causes to execute: a priority-related information storing step of storing transmission source information and destination information of a first packet in a header of a second packet which holds the first packet; and a packet transmission step of transmitting the second packet which holds transmission source information and destination information of the first packet in the header.

A relay method according to another aspect of the present invention causes to execute: a packet reception step of receiving a packet; a priority acquisition step of obtaining a priority of a packet on the basis of transmission source information and destination information included in the packet received in the packet reception step; a priority setting step of storing information indicating the priority in a header of the packet; and a packet transmission step of transmitting the packet which holds information indicating the priority in the header.

A program according to another aspect of the present invention is a program for causing a computer which controls a device including a packet reception unit which receives a packet and a received packet buffer which stores a packet received by the packet reception unit, to execute: a priority acquisition step of obtaining a priority of a packet on the basis of transmission source information and destination information included in the packet received by the packet reception unit; and a packet arrangement order adjustment step of changing an order of the packets stored in the received packet buffer to an order in accordance with the priority.

A program according to still another aspect of the present invention is a program for causing a computer to execute: a packet reception step of receiving a packet;

a priority acquisition step of obtaining a priority of a packet on the basis of transmission source information and destination information included in the packet received in the packet reception step; a priority setting step of storing information indicating the priority in a header of the packet; and a packet transmission step of transmitting the packet which holds information indicating the priority in the header.

### Advantageous Effects of Invention

According to the present invention, more flexible priority setting to a session in packet communication is possible.

### BRIEF DESCRIPTION OF DRAWINGS

FIG. 1 is a schematic block diagram illustrating a functional configuration of a packet communication system in a first exemplary embodiment of the present invention.

FIG. 2 is an explanatory diagram illustrating an example of a data structure of a receiving queue stored in a received packet buffer in the exemplary embodiment.

FIG. 3 is an explanatory diagram illustrating an example of a data structure of a priority table which is stored in a priority table storage unit in the exemplary embodiment.

FIG. 4 is an explanatory diagram illustrating an example of a structure of an SIP protocol.

FIG. 5 is an explanatory diagram illustrating an example of a priority generated by a priority acquisition unit in the exemplary embodiment.

FIG. 6 is a flowchart illustrating an example of a procedure of processing performed by a reception-side device in the exemplary embodiment.

FIG. 7 is an explanatory diagram illustrating an example of a schematic structure of a packet acquired by a packet reception unit in the exemplary embodiment.

FIG. 8 is a schematic block diagram illustrating a functional configuration of a packet communication system in a second exemplary embodiment of the present invention.

FIG. 9 is a flowchart illustrating an example of a procedure of processing performed by a packet generation unit and a priority-related information storing unit in the exemplary embodiment.

FIG. 10 is a schematic block diagram illustrating a functional configuration of a packet communication system in a third exemplary embodiment of the present invention.

FIG. 11 is a flowchart illustrating an example of a procedure of processing performed by a relay device in the exemplary embodiment.

FIG. 12 is a schematic block diagram illustrating a first example of a functional configuration of a device with a minimum configuration in the present invention.

FIG. 13 is a schematic block diagram illustrating a second example of the functional configuration of the device with a minimum configuration in the present invention.

FIG. 14 is a schematic block diagram illustrating a third example of the functional configuration of the device with a minimum configuration in the present invention.

FIG. 15 is a schematic block diagram illustrating a first example of a functional configuration of a session processing quality stabilization system with a minimum configuration in the present invention.

FIG. 16 is a schematic block diagram illustrating a second example of the functional configuration of the session processing quality stabilization system with a minimum configuration in the present invention.

### DESCRIPTION OF EMBODIMENTS

Hereinafter, exemplary embodiments of the present invention are described, but the following exemplary embodiments do not limit the invention according to the scope of claims. In addition, all the combinations of the features described in the exemplary embodiments are not necessarily essential to the solution of the invention.

### First Exemplary Embodiment

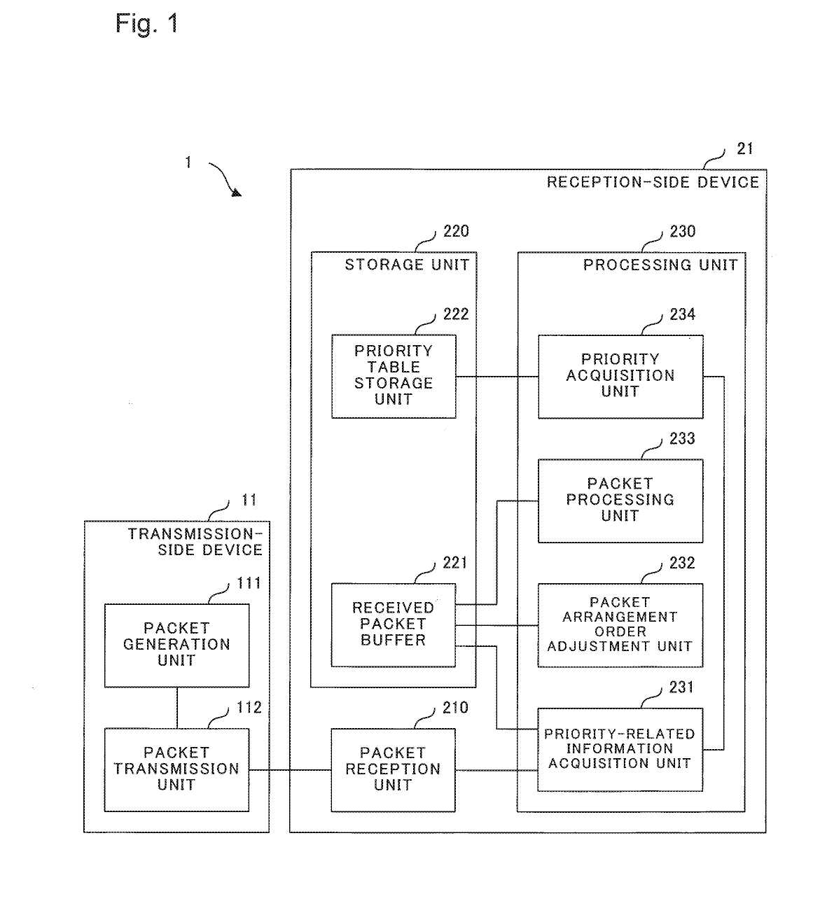

FIG. 1 is a schematic block diagram illustrating a functional configuration of a packet communication system in a first exemplary embodiment of the present invention. In the drawing, the packet communication system 1 includes a transmission-side device 11 and a reception-side device 21.

The transmission-side device 11 includes a packet generation unit 111 and a packet transmission unit 112. The reception-side device 21 includes a packet reception unit 210, a storage unit 220, and a processing unit 230.

The storage unit 220 includes a received packet buffer 221 and a priority table storage unit 222.

The processing unit 230 includes a priority-related information acquisition unit 231, a packet arrangement order adjustment unit 232, a packet processing unit 233, and a priority acquisition unit 234.

The packet communication system 1 performs packet communication between the transmission-side device 11 and the reception-side device 21. The reception-side device 21 processes a received packet in the order in accordance with a priority. In this point, the packet communication system 1 corresponds to an example of a session processing quality stabilization system.

The session mentioned herein is a series of communications. In addition, the session processing quality stabilization mentioned herein is to reduce delay of the session to be processed promptly.

The transmission-side device 11 is connected with the reception-side device 21 through a communication network, and generates a packet to transmit the packet to the reception-side device 21. Specifically, the packet generation unit 111 generates a SIP packet, and the packet transmission unit 112 transmits the packet to the reception-side device 21.

The transmission-side device 11 is configured by executing a program by a computer, for example. Alternatively, the transmission-side device 11 may be configured by another aspect other than a computer, for example, configured by a communication device.

The packet generated by the packet generation unit 111 is not limited to the SIP packet, but may be various packets from which a transmission source and a destination can be extracted.

The packet generation unit 111 may be configured as a SIP server device. In this way, the transmission-side device 11 may be configured by a plurality of devices. Similarly, the reception-side device 21 may be configured by a plurality of devices.

The reception-side device 21 receives the packet transmitted by the transmission-side device 11, and acquires a priority for each packet to process the packet in the order in accordance with the priority. The reception-side device 21 is configured by executing a program by a computer, for example. Alternatively, the reception-side device 21 may be configured by an aspect other than a computer, for example, configured by a combination of a communication device and a session processing quality stabilization device.

The reception-side device 21 corresponds to an example of the device in the present exemplary embodiment.

Note that the present exemplary embodiment describes a case in which data is transmitted from the transmission-side device 11 to the reception-side device 21, but data may be transmitted from the reception-side device 21 to the transmission-side device 11.

The packet reception unit 210 receives the packet transmitted from the transmission-side device 11 through the network. The packet reception unit 210 outputs the received packet to the priority-related information acquisition unit 231. Note that the packet reception unit 210 does not determine whether or not the received packet is addressed to the reception-side device 21.

The storage unit 220 is configured by a storage device included in the reception-side device 21, and stores various data.

The received packet buffer 221 stores the receiving queue which stores the received packet (packet received by the packet reception unit 210).

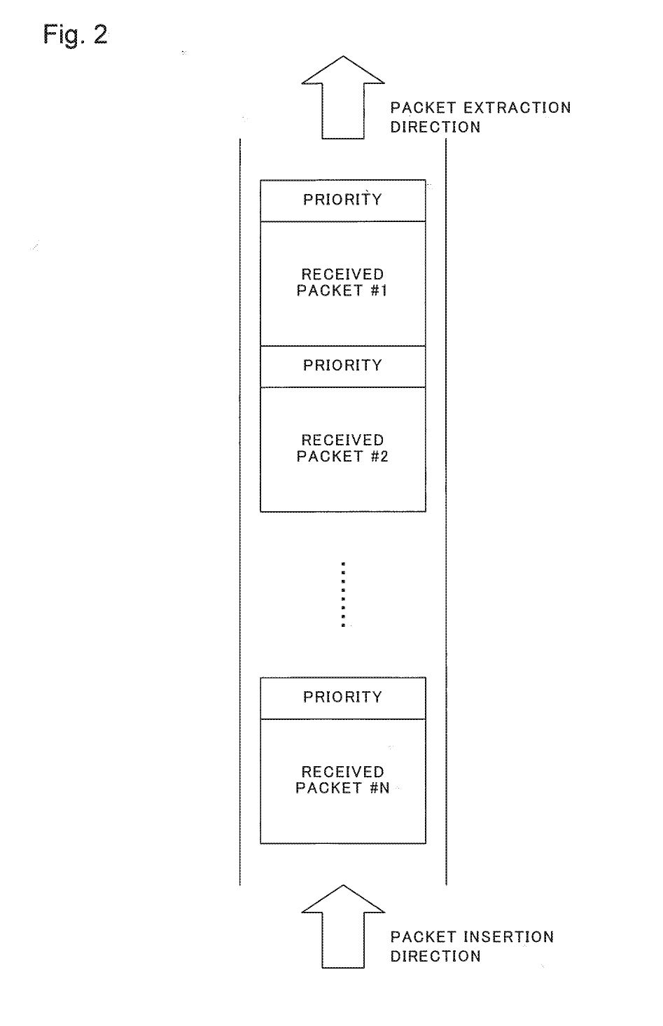

FIG. 2 is an explanatory diagram illustrating an example of a data structure of the receiving queue stored in the received packet buffer 221.

The priority is assigned to the received packet by the priority-related information acquisition unit 231, and the received packet buffer 221 stores the received packet in association with the priority of the received packet.

Specifically, the priority-related information acquisition unit 231 inserts the combination of the received packet and the priority into the received packet buffer 221 in the order of packet reception in a packet insertion direction (from an entrance of queue).

The priority table storage unit 222 stores in advance a priority table indicating a correspondence relationship between the information on a request source (a From entry) or a request destination (a To entry), and the priority.

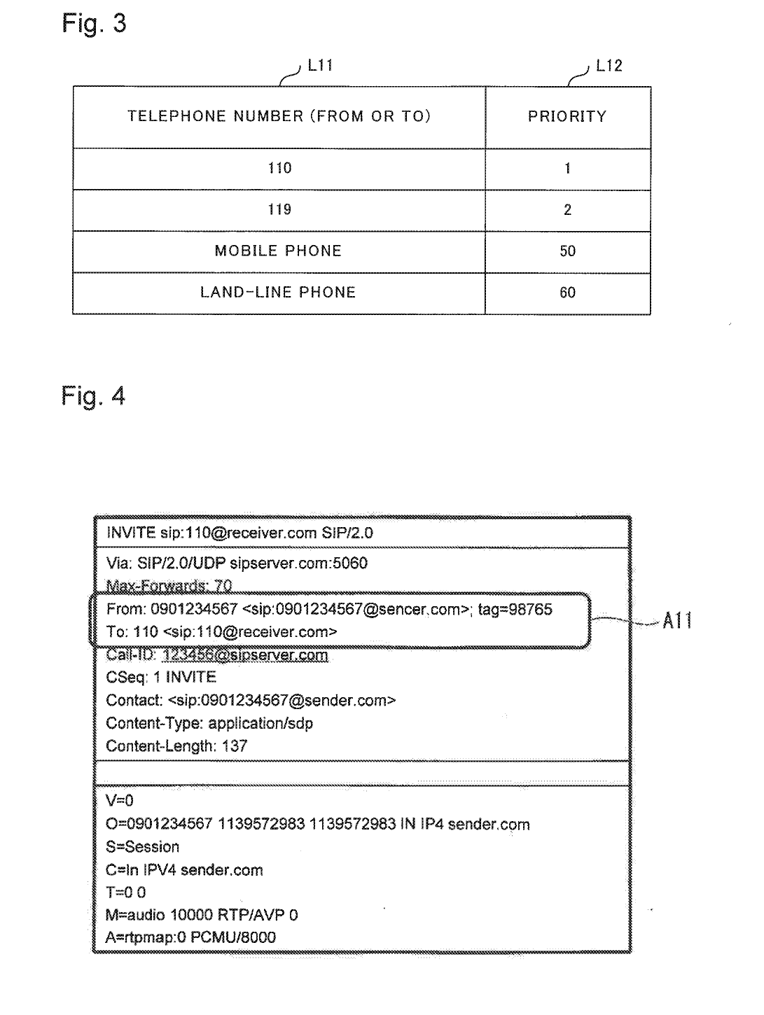

FIG. 3 is an explanatory diagram illustrating an example of a data structure of a priority table which is stored in the priority table storage unit 222. In the drawing, each row of the priority table is configured including one telephone number field illustrated in a column L11 and one priority field illustrated in a column L12, and shows a correspondence relationship between the telephone number and the priority. The telephone number in the telephone number field corresponds to the From entry or the To entry in SIP. As to the priority in the priority field, the smaller a value of the priority is, the higher the priority is.

For example, when the From entry includes “110”, the priority acquisition unit 234 reads the corresponding priority “1” from the priority table. By contrast, when the From entry includes a normal number (user ID, or the like), the priority acquisition unit 234 reads the priority “60” associated therewith from the priority table.

The processing unit 230 controls each unit of the reception-side device 21, and performs various processes. The processing unit 230 is configured by reading a program from the storage unit 220 by a CPU (Central Processing Unit) included in the reception-side device 21 and executing the program, for example.

The priority-related information acquisition unit 231 extracts information on the request source (From entry) and the request destination (To entry) from the packet received by the packet reception unit 210, and requests the priority acquisition unit 234 to set the priority. In addition, the priority-related information acquisition unit 231 stores the priority obtained from the priority acquisition unit 234 and the packet in association with each other in the receiving queue stored in the received packet buffer 221.

The priority acquisition unit 234 converts the information on the request source (From entry) and the request destination (To entry) output from the priority-related information acquisition unit 231 into respective priorities, on the basis of the priority table stored in the priority table storage unit 222, and calculates (generates) a priority of the session (priority of the packet) using the converted priorities. The priority acquisition unit 234 outputs the obtained priority to the priority-related information acquisition unit 231.

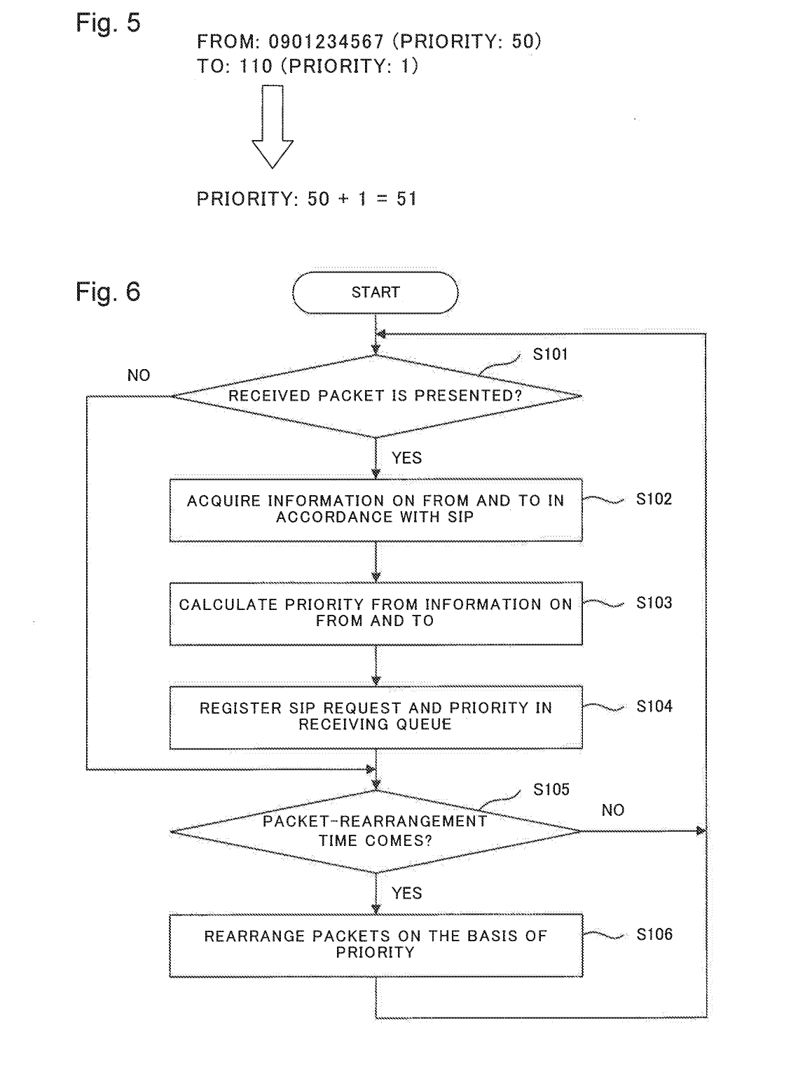

With reference to FIG. 4 and FIG. 5, a procedure of processing in which the priority acquisition unit 234 generates the priority on the basis of SIP is described.

FIG. 4 is an explanatory diagram illustrating an example of a structure of a SIP.

The row of From and the row of To are illustrated in an area A11 of the drawing. From illustrated in the area A11 includes “0901234567”, and To includes “110”. The priority acquisition unit 234 compares each of these From entry and To entry with the telephone number field of the priority table, and reads a priority from the associated row of the telephone number field.

FIG. 5 is an explanatory diagram illustrating an example of the priority generated by the priority acquisition unit 234.

The priority acquisition unit 234 converts the From entry and the To entry into priorities first, using the priority table.

In the example of FIG. 5, the From entry “0901234567” includes three figures “090” from the left. The telephone numbers which start in “090”, “080”, or “070” are phone numbers for mobile phones in Japan. In this case, the priority acquisition unit 234 reads a priority “50” from the row of “mobile phone” of the priority table in FIG. 3.

In addition, the priority acquisition unit 234 reads a priority “1” associated with “110” of the To entry from the priority table.

Next, the priority acquisition unit 234 calculates (generates) the priority of the session (priority of the packet) by adding the priority of the From entry and the priority of the To entry. In the exemplary case of FIG. 5, the priority acquisition unit 234 calculates the priority “51” by adding “50” and “1”. The priority acquisition unit 234 outputs the obtained priority “51” to the priority-related information acquisition unit 231.

Note that the example of FIG. 5 illustrates a method for generating the priority by the addition, but various priority generation methods using the From entry, the To entry, and the priority table can be applied.

For example, the priority acquisition unit 234 may multiply the priority of the From entry by the priority of the To entry. Alternatively, the priority acquisition unit 234 may select higher one (smaller one in its value) of the priority of the From entry and the priority of the To entry as the priority of the SIP session (priority of the packet).

The packet arrangement order adjustment unit 232 rearranges packets arranged in the receiving queue stored in the received packet buffer 221 in accordance with the priority. Specifically, the packet arrangement order adjustment unit 232 rearranges the packet with the higher priority to a head side of the queue, and rearranges the packet with the lower priority and a packet not associated with a priority to an end side of the queue.

The packet arrangement order adjustment unit 232 periodically rearranges the packets in the receiving queue stored in the received packet buffer 221 by using a timer, for example.

In a general communication device, a protocol processing thread sequentially extracts packets with the earliest arriving order among the packets stored in the receiving queue from the head of the queue to process the packets. Meanwhile, in the reception-side device 21, the packet with higher priority is arranged on the head side of the queue since the packet arrangement order adjustment unit 232 periodically performs rearrangement of the received packet buffer 221.

The packet processing unit 233 is a protocol processing thread, and processes the packet stored in the receiving queue which is stored in the received packet buffer 221. The packet processing unit 233 extracts the packets sequentially from an exit side (in the packet extraction direction in the example of FIG. 2) of the receiving queue to process the packets. Hereby, the packet processing unit 233 processes the packets in the order from the higher priority.

In this way, the priority acquisition unit 234 generates the priority for each of the packets acquired by the packet reception unit 210, and the packet arrangement order adjustment unit 232 rearranges the packets in the queue of the received packet buffer 221 in accordance with the priority, whereby a situation may be avoidable in which processing of the SIP session with the higher priority is performed later than packet processing for the lower priority. In this point, according to the reception-side device 21, a session processing quality is stabilized.

Next, an operation of the reception-side device 21 is described with reference to FIG. 6.

FIG. 6 is a flowchart illustrating an example of a procedure of processing performed by the reception-side device 21. When the reception-side device 21 is connected to the power supply (turned on) to be in an operating state, the device performs processing in the drawing.

In the processing in FIG. 6, the priority-related information acquisition unit 231 determines the presence or absence of the packet newly received by the packet reception unit 210 (step S101).

When it is determined that the packet newly received is presented (step S101: YES), the priority-related information acquisition unit 231 extracts the information on the request source (From entry) and the request destination (To entry) from the packet (step S102).

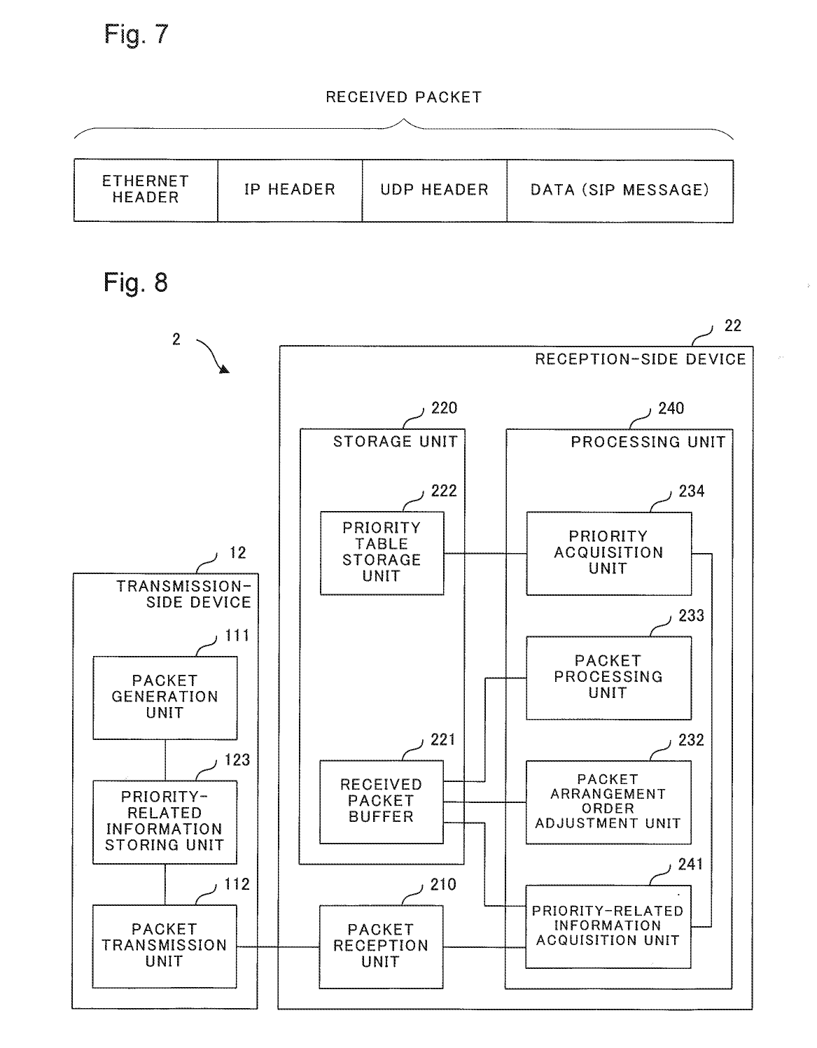

Here, with reference to FIG. 7, how the priority-related information acquisition unit 231 extracts the information on the From entry and the To entry is described.

FIG. 7 is an explanatory diagram illustrating an example of a schematic structure of the packet acquired (received) by the packet reception unit 210. An Ethernet (registered trademark) header, an IP (Internet Protocol) header, a UDP (User Datagram Protocol) header, and data (a SIP message which is a data section of a UDP packet) illustrated in the drawing have variable length. In each header, at least,

1. length of the header and data, and
2. type of subsequent protocol
are described.

For example, when a received-packet size is 100 bytes and the Ethernet (registered trademark) header is 22 bytes, the length of the data for the received packet (Ethernet (registered trademark) packet) is 78 bytes. The data includes a packet of the subsequent protocol, which is an IP packet in the example of FIG. 7.

Then, when the header length of the IP packet is 40 bytes, the length of the data of the IP packet is 38 bytes.

In this way, the priority-related information acquisition unit 231 can follow the packet configuration inside the received packet on the basis of the length of the header and data described in the header, and the type of subsequent protocol. In particular, the priority-related information acquisition unit 231 can arrive at the SIP message.

The SIP message illustrated in FIG. 7 is text data, and the priority-related information acquisition unit 231 can refer to the contents of each of rows separated by a line feed. The priority-related information acquisition unit 231 detects the row which includes “From:” at the head and the row which includes “To:” at the head from the SIP message, thereby extracting the From entry and the To entry.

Returning to FIG. 6, after step S102, the priority acquisition unit 234 converts the From entry and the To entry acquired by the priority-related information acquisition unit 231 to priorities (step S103). Specifically, the priority-related information acquisition unit 231 notifies the priority acquisition unit 234 of the information on the From entry and the To entry acquired in step S102. Then, the priority acquisition unit 234 converts both the From entry and the To entry to the priorities as mentioned above, using the priority table stored in the priority table storage unit 222, and calculates (generates) the priority of the session (priority of the packet) on the basis of the priorities.

Next, the priority-related information acquisition unit 231 registers the SIP request and the above-mentioned priority in the receiving queue of the received packet buffer 221 in association with each other (step S104).

Next, the packet arrangement order adjustment unit 232 determines whether or not the packet-rearrangement time comes (step S105). The rearrangement time is set in advance, for example, before the reception-side device 21 processes the received packet.

When it is determined that the rearrangement time comes (step S105: YES), the packet arrangement order adjustment unit 232 rearranges the packets on the basis of the priority (step S106).

Processing returns to step S101 after step S106.

By contrast, when it is determined that the rearrangement time does not come (step S105: NO), it returns to step S101 without rearranging the packets.

When it is determined that there is no received packet in step S101 (step S101: NO), processing proceeds to step S105.

As described above, the priority acquisition unit 234 obtains the priority of the received packet on the basis of the transmission source information and the destination information which are included in the received packet. The packet arrangement order adjustment unit 232 then changes the order of the packets stored in the received packet buffer 221 to the order in accordance with the priority.

Hereby, the reception-side device 21 can process the packets in the order of the priority based on the transmission source and the destination of each packet. In this point, more flexible priority setting is possible with the reception-side device 21.

In particular, the priority-related information acquisition unit 231 can set a priority to each SIP session by acquiring a priority on the basis of the transmission source and the destination of each received packet. Hereby, the reception-side device 21 can distinguish a SIP session to which priority is to be given and another SIP session, and can process the SIP session to which priority is to be given earlier.

The transmission-side device 11 transmits the packet of the multi-layered structure as illustrated by the example of FIG. 7. In other words, the transmission-side device 11 transmits a second packet which holds a first packet. The priority acquisition unit obtains a priority of the first packet on the basis of transmission source information and destination information of the first packet included in the second packet.

Hereby, the receiving device 21 can set a priority appropriately on the basis of information on an inner packet which serves as a processing object in a state before the inner packet in the multi-layered structure is extracted.

The received packet buffer 221 stores the second packet which holds the first packet and the priority of the second packet in association with each other in the packet with the multi-layered structure. The packet arrangement order adjustment unit 232 rearranges second packets stored in the received packet buffer 221 in accordance with the priority associated with each second packet.

Hereby, the packet processing unit 233 can acquire the packets in order of the priority by simple processing in which the packets are extracted from the received packet buffer 221 in an order in a queue. In particular, the packet processing unit 233 can process a SIP session with a higher priority preferentially, and can implement stabilization of session processing quality.

The priority table storage unit 222 stores the priority table indicating the correspondence relationship between the transmission source or the destination, and the priority.

Hereby, the priority acquisition unit 234 can obtain the priority of the packet easily with reference to the priority table.

### Second Exemplary Embodiment

FIG. 8 is a schematic block diagram illustrating a functional configuration of a packet communication system in a second exemplary embodiment of the present invention. In the drawing, a packet communication system 2 includes a transmission-side device 12 and a reception-side device 22.

The transmission-side device 12 includes a packet generation unit 111, a packet transmission unit 112, and a priority-related information storing unit 123.

The reception-side device 22 includes a packet reception unit 210, a storage unit 220, and a processing unit 240.

The storage unit 220 includes a received packet buffer 221 and a priority table storage unit 222.

The processing unit 240 includes a packet arrangement order adjustment unit 232, a packet processing unit 233, a priority acquisition unit 234, and a priority-related information acquisition unit 241.

In FIG. 8, the same signs (111 to 112, 210, 220 to 222, 232 to 234) are given to the components which correspond to components in FIG. 1 and have the same functions as the components, and the description thereof is omitted.

The packet communication system 2 performs packet communication between the transmission-side device 12 and the reception-side device 22, like the packet communication system 1 (FIG. 1). The reception-side device 22 processes received packets in the order based on a priority. In this point, the packet communication system 2 corresponds to an example of a session processing quality stabilization system.

In addition, each of the transmission-side device 12 and the reception-side device 22 corresponds to an example of a device in the present exemplary embodiment.

Like the transmission-side device 11 (FIG. 1), the transmission-side device 12 is configured by executing a program by a computer, for example. Alternatively, the transmission-side device 12 may be configured by another aspect other than a computer, for example, configured by a communication device.

Like the reception-side device 21 (FIG. 1), the reception-side device 22 is configured by executing a program by a computer, for example. Alternatively, the reception-side device 22 may be configured by an aspect other than a computer, for example, configured by a combination of a communication device and a session processing quality stabilization device.

The priority-related information storing unit 123 extracts the From entry and the To entry from a SIP request, and inserts the entry data in an option field of a packet header.

More specifically, the packet generation unit 111 generates a transmission packet from the SIP request, and outputs the packet to the priority-related information storing unit 123. The priority-related information storing unit 123 extracts the From entry and the To entry from the SIP message included in the packet, and inserts the entry data in the option field of the IP header. The priority-related information storing unit 123 outputs the obtained transmission packet to the packet transmission unit 112.

The packet transmission unit 112 transmits the transmission packet to which the priority-related information storing unit 123 inserts the entry data in the header, to the reception-side device 21.

Like the priority-related information acquisition unit 231 (FIG. 1) in the first exemplary embodiment, the priority-related information acquisition unit 241 extracts information on the request source (From entry) and the request destination (To entry) from the packet received by the packet reception unit 210, and requests the priority acquisition unit 234 to set the priority.

However, unlike the priority-related information acquisition unit 231, the priority-related information acquisition unit 241 extracts the information on the From entry and the To entry from the option field of the IP header.

Note that when the received packet including the option field and the received packet not including the option field exists, the priority-related information acquisition unit 241 can determine the presence or absence of the option field by checking an IP header length.

The IP header can be classified into a basis section and an optional section. Since the basis section has a fixed length of 40 bytes, the option field exists when the header length of IP header includes a numerical value of 40 bytes or larger.

Alternatively, in the transmission-side device 12, the priority-related information storing unit 123 may be configured to insert, into the head of the option field, an identifier which illustrates that the information on the From entry and the To entry is inserted. The priority-related information acquisition unit 241 can determine whether or not the information on the From entry and the To entry is included in the IP header by determining the presence or absence of the identifier.

When the option field is not included in the IP header, or when the information on the From entry and the To entry is not inserted in the option field, the priority-related information acquisition unit 241 may handle the packet as a packet with no priority setting. Alternatively, the priority-related information acquisition unit 241 may be configured to acquire the information on the From entry and the To entry from the SIP message, like the priority-related information acquisition unit 231.

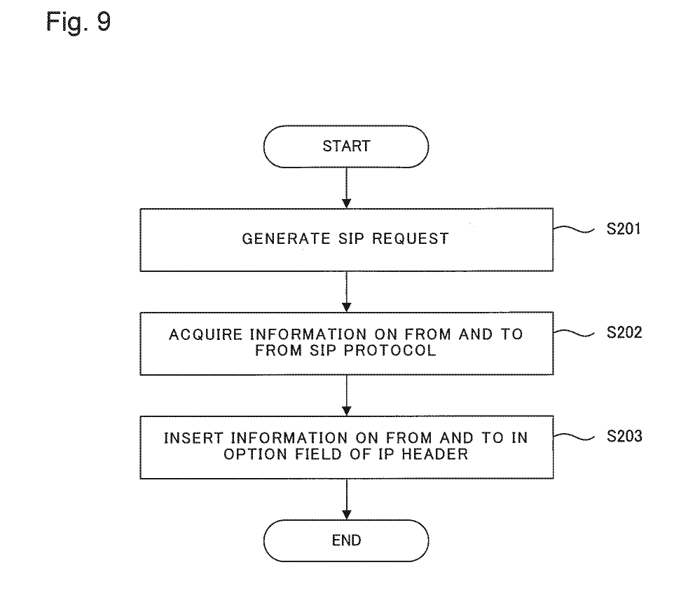

Next, with reference to FIG. 9, an operation of the priority-related information storing unit 123 is described.

FIG. 9 is a flowchart illustrating an example of a procedure of processing performed by the packet generation unit 111 and the priority-related information storing unit 123.

In the processing of the drawing, the packet generation unit 111 generates an Ethernet (registered trademark) packet which illustrates the SIP request (step S201).

Next, the priority-related information storing unit 123 extracts the From entry and the To entry from a SIP protocol (SIP message stored in the data section of the packet generated by the packet generation unit 111) (step S202).

The priority-related information storing unit 123 then inserts the information on the From entry and the To entry in the option field of the IP header (step S203).

After that, processing of FIG. 9 is terminated. The packet transmission unit 112 transmits the packet to the reception-side device 22 after the processing of FIG. 9.

Regarding the operation of the reception-side device 22, the processing performed by the priority-related information acquisition unit 241 is different from the processing performed by the priority-related information acquisition unit 231 (FIG. 1) in the first exemplary embodiment. Specifically, the priority-related information acquisition unit 231 detects the From entry and the To entry of the SIP message with reference to the header length of each header. By contrast, the priority-related information acquisition unit 241 acquires the From entry and the To entry from the IP header option.

Other processing performed by the reception-side device 22 is the same as the processing performed by the receiving device 21.

As described above, the priority-related information storing unit 123 stores the transmission source information and the destination information of the first packet in the header of the second packet, which holds the first packet in a packet with the multi-layered structure.

Hereby, the priority-related information acquisition unit 241 can acquire the transmission source information and the destination information from the header of the second packet. Therefore, the priority-related information acquisition unit 241 does not need to perform processing, which follows each header until the SIP message is reached, described with reference to FIG. 7. At this point, the processing load of the priority-related information acquisition unit 241 can be reduced.

For example, the priority-related information storing unit 123 inserts, in the option field of the IP header, the information indicating the From entry and the To entry of the SIP request as mentioned above. Then, in order to extract the From entry and the To entry, the priority-related information acquisition unit 241 refers to each header until the IP header is reached. In this way, a procedure for the priority-related information acquisition unit 241 to acquire the From entry and the To entry can be shortened.

### Third Exemplary Embodiment

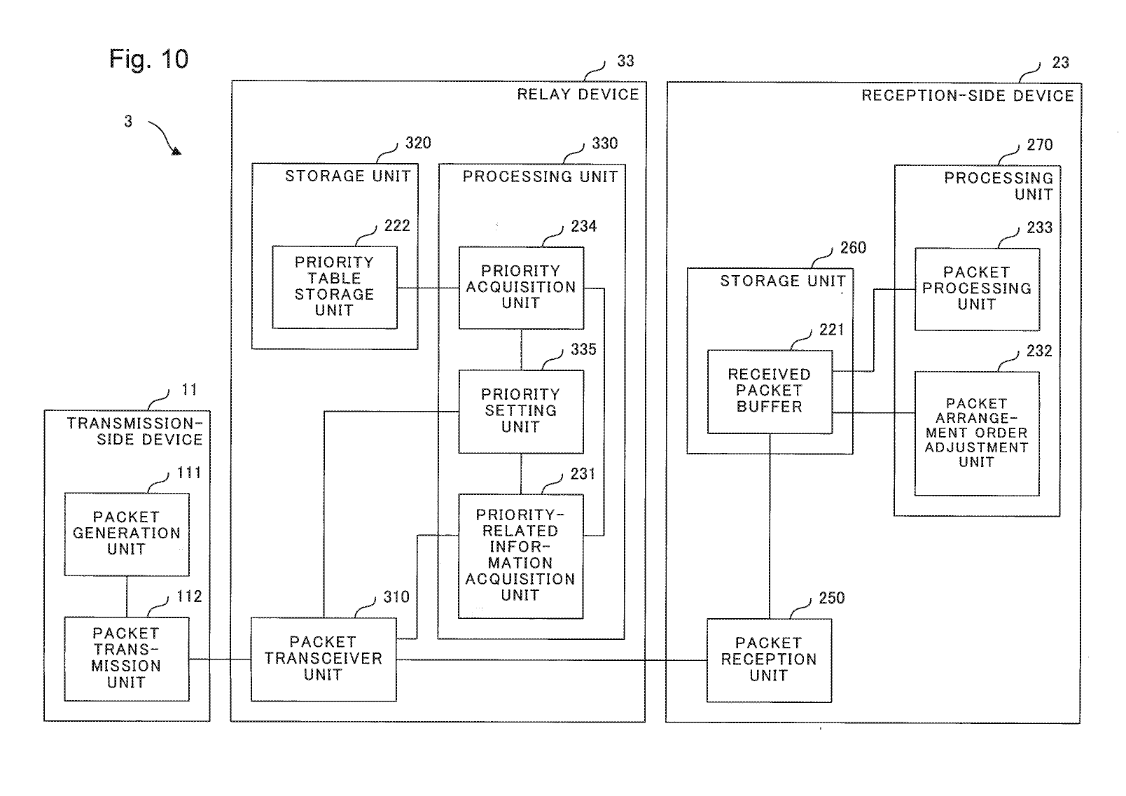

FIG. 10 is a schematic block diagram illustrating a functional configuration of a packet communication system in a third exemplary embodiment of the present invention. In the drawing, the packet communication system 3 includes a transmission-side device 11, a reception-side device 23 and a relay device 33.

The transmission-side device 11 includes a packet generation unit 111 and a packet transmission unit 112.

The reception-side device 23 includes a packet reception unit 250, a storage unit 260, and a processing unit 270. The storage unit 260 includes a received packet buffer 221. The processing unit 270 includes a packet arrangement order adjustment unit 232 and a packet processing unit 233.

The relay device 33 includes a packet transceiver unit 310, a storage unit 320, and a processing unit 330. The storage unit 320 includes a priority table storage unit 222. The processing unit 330 includes a priority-related information acquisition unit 231, a priority acquisition unit 234, and a priority setting unit 335.

In FIG. 10, the same signs (11, 111 to 112, 221 to 222, 231 to 234) are given to the components which correspond to components in FIG. 1 and have the same functions as the components, and the description thereof is omitted.

The packet communication system 3 performs packet communication between the transmission-side device 11 and the reception-side device 23, like the packet communication system 1 (FIG. 1). However, unlike the packet communication system 1, the relay device 33 relays the communication between the transmission-side device 11 and the reception-side device 23 in the present packet communication system 3.

The reception-side device 23 processes received packets in the order based on a priority, like the reception-side device 21 in the packet communication system 1. In this point, the packet communication system 3 corresponds to an example of a session processing quality stabilization system. The relay device 33 also corresponds to an example of the device in the present exemplary embodiment.

Like the reception-side device 21 (FIG. 1), the reception-side device 23 is configured by executing a program by a computer, for example. Alternatively, the reception-side device 23 may be configured by an aspect other than a computer, for example, configured by a combination of a communication device and a session processing quality stabilization device.

As is the case with the first exemplary embodiment, the transmission-side device 11 transmits a SIP request packet to the reception-side device 23. In this case, unlike the transmission-side device 12 in the second exemplary embodiment, the transmission-side device 11 does not insert a From entry and a To entry in an option field of an IP protocol.

The relay device 33 performs processing for priority setting to the packet transmitted by the transmission-side device 11 to the reception-side device 21, but the transmission-side device 11 has no concern whether or not the relay device 33 has received the packet on the way.

The relay device 33 relays the packet transmitted by the transmission-side device 11 to the reception-side device 21. At that time, the relay device 33 performs processing for priority setting to the packet. The relay device 33 is configured by executing a program by a computer, for example. Alternatively, the relay device 33 may be configured by an aspect other than a computer, for example, configured by a combination of a communication device and a session processing quality stabilization device.

The priority-related information acquisition unit 231 extracts the From entry and the To entry from the SIP request packet, as is the case with the first exemplary embodiment. The priority-related information acquisition unit 231 notifies the priority acquisition unit 234 of the acquired From entry and To entry. The way the priority-related information acquisition unit 231 extracts the From and To entries is the same as or similar to the way described in the first exemplary embodiment.

The priority-related information acquisition unit 231 outputs the received packet from which the From entry and the To entry are extracted to the priority setting unit 335.

As is the case with the first exemplary embodiment, the priority acquisition unit 234 converts the From entry and the To entry output from the priority-related information acquisition unit 231 into priorities of the packet, using the priority table stored in the priority table storage unit 222. The priority acquisition unit 234 calculates a priority of the packet using the priorities obtained by the conversion, and outputs this priority to the priority setting unit 335.

The priority setting unit 335 generates a SIP request packet to be transmitted to the reception-side device 21 on the basis of the priority output from the priority acquisition unit 234 and the received packet output from the priority-related information acquisition unit 231. Specifically, the priority setting unit 335 provides the IP option field in the received packet, and inserts the priority in the option field.

The priority setting unit 335 outputs the generated SIP request packet to the packet transceiver unit 310. The packet transceiver unit 310 transmits the packet to the reception-side device 23.

In the reception-side device 23, the packet reception unit 250 receives the packet which is transmitted by the transmission-side device 11 and relayed by the relay device 33.

The packet reception unit 250 extracts the information indicating the priority from the IP option field of the received packet, and inserts a set of the information indicating the priority and the received packet in the receiving queue stored in the received packet buffer 221.

Next, an operation of the relay device 33 is described with reference to FIG. 11.

FIG. 11 is a flowchart illustrating an example of a procedure of processing performed by the relay device 33.

In the processing illustrated in the drawing, the priority-related information acquisition unit 231 extracts the From entry and the To entry from the received packet transmitted from the transmission-side device 11 (step S301).

Next, the priority acquisition unit 234 converts the From entry and the To entry into the priorities of the packet with reference to the priority table stored in the priority table storage unit 222, and calculates the priority of the packet using the priorities (step S302).

The priority setting unit 335 provides the IP header option field in the received packet, and inserts the priority in the option field (step S303).

The processing illustrated in FIG. 11 is terminated after step S303.

After the processing illustrated in FIG. 11, the packet transceiver unit 310 transmits to the reception-side device 23 the packet from the priority setting unit 335.

In the reception-side device 23, the packet reception unit 250 receives the packet from the relay device 33. The packet reception unit 250 extracts the information indicating the priority from the IP option field of the received packet, and inserts a set of the information indicating the priority and the received packet in the receiving queue of the received packet buffer 221. The rearrangement operation for packets performed by the packet processing unit 233 is the same as or similar to the operation in the first exemplary embodiment.

As described above, the priority acquisition unit 234 obtains a priority of the packet on the basis of transmission source information and destination information which are included in the packet received by the packet transceiver unit 310. The priority setting unit 335 stores information indicating the priority in the header of the packet.

Hereby, the reception-side device 23 which receives the packet from the relay device 33 can acquire the priority by simple processing which reads out the priority from a packet header. In this point, the load for the priority setting in the reception-side device 23 can be reduced.

The priority acquisition unit 234 obtains a priority of the first packet on the basis of transmission source information and destination information of the first packet which is an inner packet in the packet with the multi-layered structure. The priority setting unit 335 stores the information indicating the priority in the header of the second packet which is an outer packet in the packet with the multi-layered structure.

Hereby, the receiving device 23 can set a priority appropriately on the basis of information on an inner packet which serves as a processing object in a state before the inner packet in the multi-layered structure is extracted.

The received packet buffer 221 stores the second packet and the priority of the second packet in association with each other, as is the case with the first exemplary embodiment. The packet arrangement order adjustment unit 232 rearranges second packets stored in the received packet buffer in accordance with the priority associated with each second packet.

Hereby, the packet processing unit 233 can acquire the packets in order of the priority by simple processing in which the packets are extracted from the received packet buffer 221 in the order in a queue. In particular, the packet processing unit 233 can process a SIP session with a higher priority preferentially, and can implement stabilization of session processing quality.

The priority table storage unit 222 stores the priority table indicating the correspondence relationship between the transmission source or the destination, and the priority, as is the case with the first exemplary embodiment.

Hereby, the priority acquisition unit 234 can obtain the priority of the packet easily with reference to the priority table.

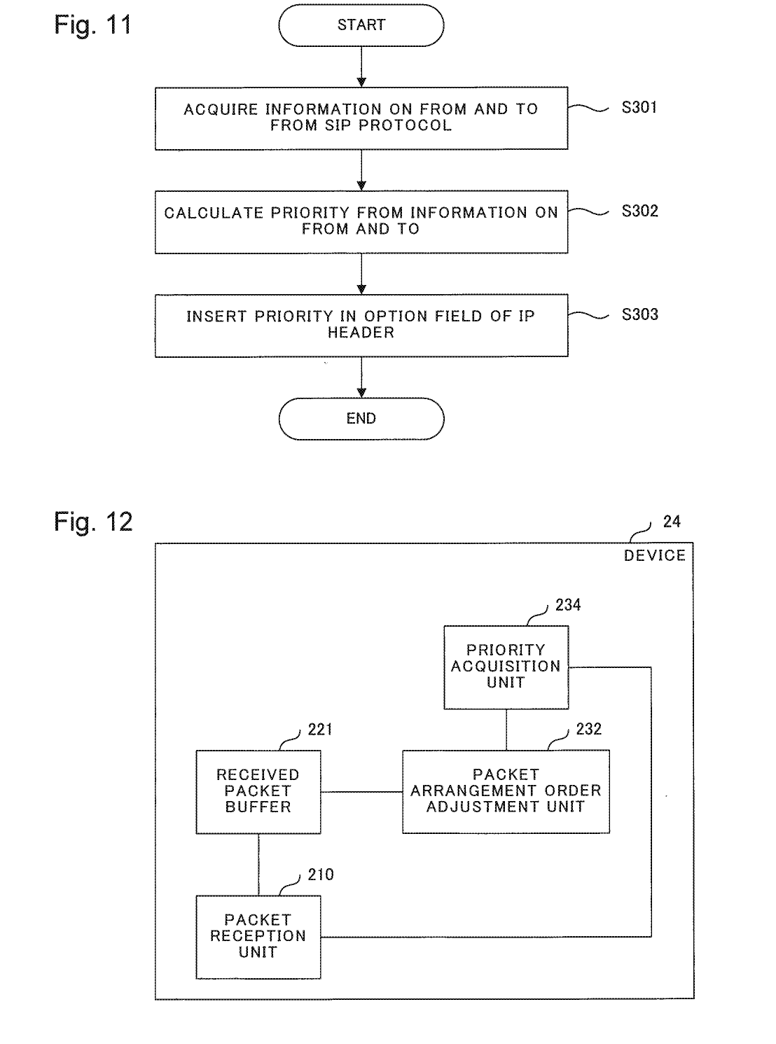

Next, minimum configurations of the present invention are described with reference to FIG. 12 to FIG. 16.

FIG. 12 is a schematic block diagram illustrating a first example of a functional configuration of a device with a minimum configuration of the present invention. In the drawing, a device 24 includes a packet reception unit 210, a received packet buffer 221, a packet arrangement order adjustment unit 232, and a priority acquisition unit 234.

In FIG. 12, the same signs (210, 221, 232, 234) are given to the components which correspond to components in FIG. 1.

In a configuration illustrated in FIG. 12, the packet reception unit 210 receives a packet. The received packet buffer 221 stores the packet received by the packet reception unit 210. The priority acquisition unit 234 obtains a priority of the packet on the basis of transmission source information and destination information which are included in the packet received by the packet reception unit 210. The packet arrangement order adjustment unit 232 changes the order of the packets stored in the received packet buffer 221 to the order in accordance with the priority.

Hereby, the device 24 can process the packets in the order of the priority based on the transmission source and the destination of each packet. In this point, more flexible priority setting is possible with the device 24.

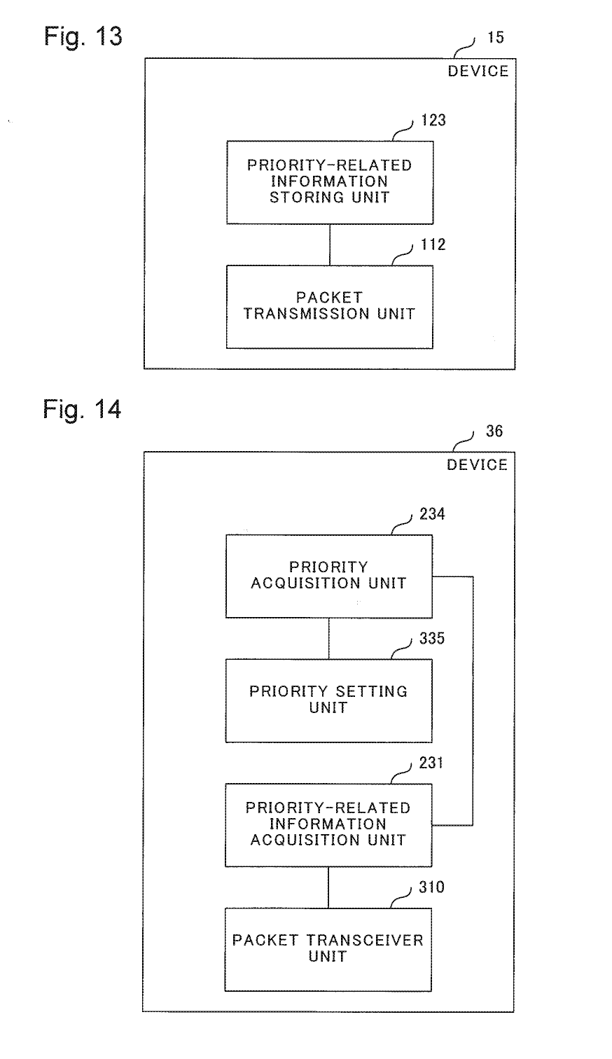

FIG. 13 is a schematic block diagram illustrating a second example of a functional configuration of a device with a minimum configuration of the present invention. In the drawing, a device 15 includes a packet transmission unit 112 and a priority-related information storing unit 123.

In FIG. 13, the same signs (112, 123) are given to the components which correspond to components in FIG. 8.

In a configuration illustrated in FIG. 13, the priority-related information storing unit 123 stores transmission source information and destination information of a first packet into a header of a second packet in which holds the first packet. The packet transmission unit 112 transmits the second packet in which the transmission source information and the destination information of the first packet are stored in the header.

Hereby, a device which receives the packet transmitted by the device 15 can acquire the transmission source information and the destination information from the header of the second packet, and can acquire the priority of the packet on the basis of the acquired information. In this way, the device which receives the packet transmitted by the device 15 can acquire the priority of the packet relatively easily, and at this point, the device can reduce processing load of the device.

FIG. 14 is a schematic block diagram illustrating a third example of a functional configuration of a device with a minimum configuration of the present invention. In the drawing, a device 36 includes a priority-related information acquisition unit 231, a priority acquisition unit 234, a packet transceiver unit 310, and a priority setting unit 335.

In FIG. 14, the same signs (231, 234, 310, 335) are given to the components which correspond to components in FIG. 10.

In a configuration illustrated in FIG. 14, the packet transceiver unit 310 receives a packet. The packet transceiver unit 310 transmits a packet in which the priority setting unit 335 stores information indicating a priority in the header.

The priority acquisition unit 234 obtains a priority of the packet on the basis of transmission source information and destination information which are included in the packet received by the packet transceiver unit 310.

The priority setting unit 335 stores information indicating the priority in the header of the packet.

Hereby, a device which receives the packet transmitted by the device 36 can acquire the priority by simple processing which reads out the priority from a packet header. In this point, the load for the priority setting in the device which receives the packet transmitted by the device 36 can be reduced.

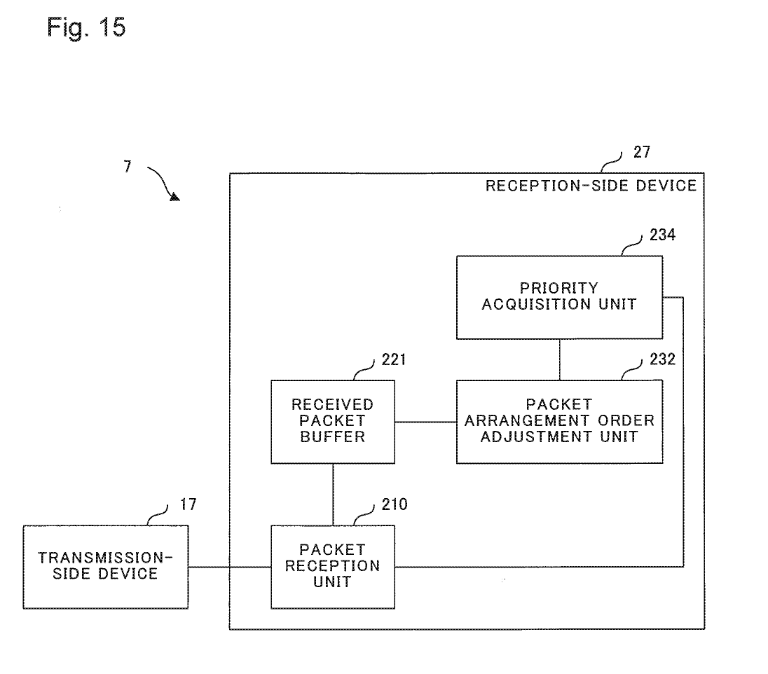

FIG. 15 is a schematic block diagram illustrating a first example of a functional configuration of a session processing quality stabilization system with a minimum configuration of the present invention. In the drawing, a session processing quality stabilization system 7 includes a transmission-side device 17 and a reception-side device 27.

The reception-side device 27 includes a packet reception unit 210, a received packet buffer 221, a packet arrangement order adjustment unit 232, and a priority acquisition unit 234.

In FIG. 15, the same signs (210, 221, 232, 234) are given to the components which correspond to components in FIG. 1.

In a configuration illustrated in FIG. 15, the packet reception unit 210 receives a packet. The received packet buffer 221 stores the packet received by the packet reception unit 210. The priority acquisition unit 234 obtains a priority of the packet on the basis of transmission source information and destination information which are included in the packet received by the packet reception unit 210. The packet arrangement order adjustment unit 232 changes the order of the packets stored in the received packet buffer 221 to the order in accordance with the priority.

Hereby, the reception-side device 27 can process the packets in the order of the priority based on the transmission source and the destination of each packet. In this point, more flexible priority setting is possible with the reception-side device 27.

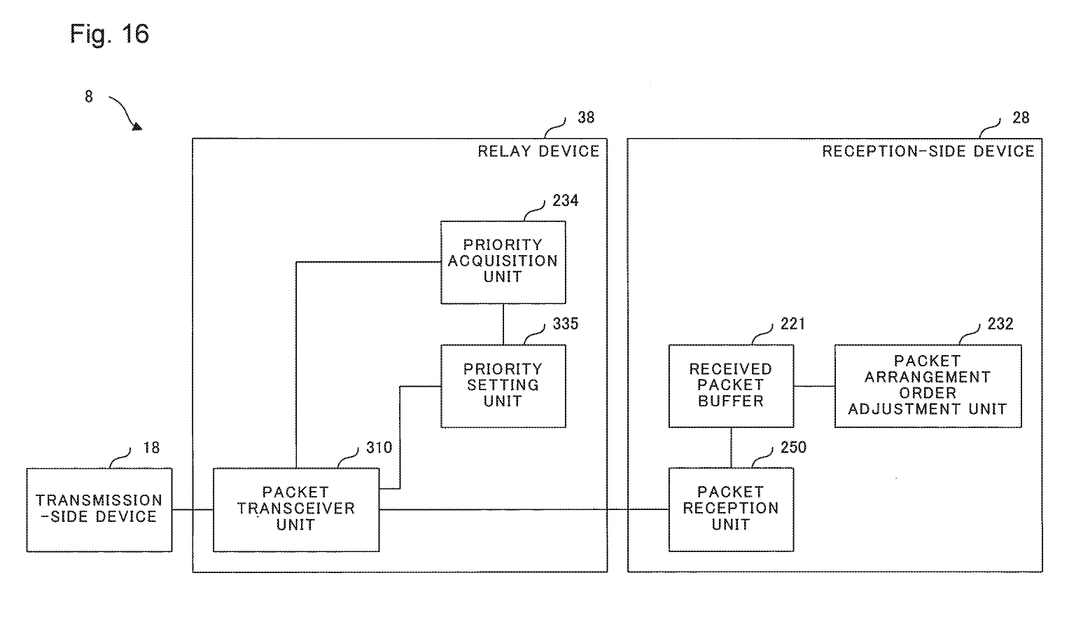

FIG. 16 is a schematic block diagram illustrating a second example of a functional configuration of a session processing quality stabilization system with a minimum configuration of the present invention. In the drawing, a session processing quality stabilization system 8 includes a transmission-side device 18, a reception-side device 28, and a relay device 38.

The reception-side device 28 includes a packet reception unit 250, a received packet buffer 221, and a packet arrangement order adjustment unit 232. The relay device 38 includes a packet transceiver unit 310, a priority acquisition unit 234, and a priority setting unit 335.

In FIG. 16, the same signs (221, 232, 234, 250, 310, 335) are given to the components which correspond to components in FIG. 10.

In a configuration illustrated in FIG. 16, the packet transceiver unit 310 transmits and receives a packet. The packet transceiver unit 310 transmits a packet in which the priority setting unit 335 stores information indicating a priority in the header. The priority acquisition unit 234 obtains a priority of the packet on the basis of transmission source information and destination information which are included in the packet received by the packet transceiver unit. The priority setting unit 335 stores information indicating the priority in the header of the packet.

The packet reception unit 250 receives the packet from the relay device 38. The received packet buffer 221 stores the packet received by the packet reception unit 250. The packet arrangement order adjustment unit 232 changes the order of the packets stored in the received packet buffer 221 to the order in accordance with information indicating the priority stored in the header.

Hereby, the reception-side device 28 which receives the packet from the relay device 38 can acquire the priority by simple processing which reads out the priority from a packet header. In this point, the load for the priority setting in the reception-side device 28 can be reduced.

Note that programs for implementing all of or a part of functions of the transmission-side device 12, the reception-side device 21, 22, 23, 27, or 28, the relay device 33 or 38, and the device 15, 24, or 36 may be recorded on a computer-readable recording medium, and the programs recorded on the recording medium may be load to a computer system and executed to perform processing of each unit.

Note that the “computer system” described herein includes OS and hardware such as peripheral equipment.

The “computer system” also includes a homepage providing environment (or display environment) when the WWW system is utilized.

The “computer-readable recording medium” means a transportable medium such as a flexible disk, a magneto-optical disk, a ROM, and a CD-ROM, and a storage device such as a hard disk embedded in a computer system.

Furthermore, the “computer-readable recording medium” also includes one which holds a program dynamically during a short time, such as a communication line in a case of transmitting a program through a network such as the Internet or a communication line such as a telephone line, and one which holds a program for a predetermined period of time such as a volatile memory inside a computer system which serves as a server or a client in that case.

The above-mentioned program may be for implementing a part of functions mentioned above, or may be for implementing the functions mentioned above in combination with a program already recorded in the computer system.

As above, although exemplary embodiments of the present invention are described in detail with reference to the drawings, a concrete configuration is not limited to the exemplary embodiments and a design variation within the scope not depart from the gist of the present invention is included.

Although some or all of above-mentioned exemplary embodiments may be described as the following supplementary notes, but are not limited to the followings.

(Supplementary Note 1) A device including: a packet reception unit which receives a packet; a received packet buffer which stores a packet received by the packet reception unit; a priority acquisition unit which obtains a priority of a packet on the basis of transmission source information and destination information included in the packet received by the packet reception unit; and a packet arrangement order adjustment unit which changes an order of the packets stored in the received packet buffer to an order in accordance with the priority.

(Supplementary Note 2) A device including: a priority-related information storing unit which stores transmission source information and destination information of a first packet in a header of a second packet which stores the first packet; and a packet transmission unit which transmits the second packet which holds transmission source information and destination information of the first packet in the header.

(Supplementary Note 3) A device including: a packet transceiver unit which transmits and receives a packet; a priority acquisition unit which obtains a priority of a packet on the basis of transmission source information and destination information included in the packet received by the packet transceiver unit; and a priority setting unit which stores information indicating the priority in a header of the packet, wherein the packet transceiver unit transmits the packet which holds information indicating the priority in the header.

(Supplementary Note 4) A session processing quality stabilization system including: a transmission-side device which transmits a packet; and a reception-side device which receives the packet, wherein the reception-side device includes: a packet reception unit which receives the packet; a received packet buffer which stores a packet received by the packet reception unit; a priority acquisition unit which obtains a priority of a packet on the basis of transmission source information and destination information included in the packet received by the packet reception unit; and a packet arrangement order adjustment unit which changes an order of the packets stored in the received packet buffer to an order in accordance with the priority.

(Supplementary Note 5) The session processing quality stabilization system according to Supplementary Note 4, wherein the transmission-side device transmits a second packet which holds a first packet, and the priority acquisition unit obtains a priority of the first packet on the basis of transmission source information and destination information of the first packet included in the second packet.

(Supplementary Note 6) The session processing quality stabilization system according to Supplementary Note 5, wherein the transmission-side device includes: a priority-related information storing unit which stores transmission source information and destination information of a first packet in a header of a second packet which holds the first packet; and a packet transmission unit which transmits the second packet including transmission source information and destination information of the first packet in a header, wherein the packet reception unit receives the second packet transmitted by the packet transmission unit, the second packet including transmission source information and destination information of the first packet in a header, and the priority acquisition unit obtains a priority of the first packet on the basis of transmission source information and destination information of the first packet stored in a header of the second packet which is received by the packet reception unit.

(Supplementary Note 7) The session processing quality stabilization system according to Supplementary Note 5 or 6, wherein the received packet buffer stores the second packet and a priority of the second packet in association with each other, and the packet arrangement order adjustment unit rearranges the second packets stored in the received packet buffer in accordance with a priority associated with the second packet.

(Supplementary Note 8) The session processing quality stabilization system according to any one of Supplementary Notes 4 to 7, wherein the reception-side device further includes a priority table storage unit which stores a priority table indicating a correspondence relationship between a transmission source or a destination, and a priority, and

the priority acquisition unit obtains a priority of the packet with reference to the priority table.

(Supplementary Note 9) A session processing quality stabilization system including: a transmission-side device which transmits a packet; a reception-side device which receives the packet; and a relay device which relays the packet from the transmission-side device to the reception-side device,

wherein the relay device includes: a packet transceiver unit which transmits and receives the packet; a priority acquisition unit which obtains a priority of a packet on the basis of transmission source information and destination information included in the packet received by the packet transceiver unit; and a priority setting unit which stores information indicating the priority in a header of the packet,

the packet transceiver unit transmits the packet which holds information indicating the priority in the header, and

the reception-side device includes: a packet reception unit which receives the packet; a received packet buffer which stores a packet received by the packet reception unit; and a packet arrangement order adjustment unit which changes an order of the packets stored in the received packet buffer to an order in accordance with information indicating the priority stored in the header.

(Supplementary Note 10) The session processing quality stabilization system according to Supplementary Note 9, wherein the transmission-side device transmits a second packet which holds a first packet, the priority acquisition unit obtains a priority of the first packet on the basis of transmission source information and destination information of the first packet, and

the priority setting unit stores information indicating the priority in a header of the second packet.

(Supplementary Note 11) The session processing quality stabilization system according to Supplementary Note 10, wherein the received packet buffer stores the second packet and a priority of the second packet in association with each other, and the packet arrangement order adjustment unit rearranges the second packets stored in the received packet buffer in accordance with a priority associated with the second packet.

(Supplementary Note 12) The session processing quality stabilization system according to any one of Supplementary Notes 9 to 11, wherein the reception-side device further includes a priority table storage unit which stores a priority table indicating a correspondence relationship between a transmission source or a destination, and a priority, and

the priority acquisition unit obtains a priority of the packet with reference to the priority table.

(Supplementary Note 13) A priority processing method causing a device including a packet reception unit which receives a packet and a received packet buffer which stores a packet received by the packet reception unit, to execute: a priority acquisition step of obtaining a priority of the packet on the basis of transmission source information and destination information included in a packet received by the packet reception unit; and a packet arrangement order adjustment step of changing an order of the packets stored in the received packet buffer to an order in accordance with the priority.

(Supplementary Note 14) A transmission method causing to execute: a priority-related information storing step of storing transmission source information and destination information of a first packet in a header of a second packet which holds the first packet; and a packet transmission step of transmitting the second packet which holds transmission source information and destination information of the first packet in the header.

(Supplementary Note 15) A relay method causing to execute: a packet reception step of receiving a packet; a priority acquisition step of obtaining a priority of the packet on the basis of transmission source information and destination information included in a packet received in the packet reception step;

a priority setting step of storing information indicating the priority in a header of the packet; and a packet transmission step of transmitting the packet which holds information indicating the priority in a header.

(Supplementary Note 16) A program for causing a computer which controls a device including a packet reception unit which receives a packet and a received packet buffer which stores a packet received by the packet reception unit, to execute: a priority acquisition step of obtaining a priority of the packet on the basis of transmission source information and destination information included in a packet received by the packet reception unit; and a packet arrangement order adjustment step of changing an order of the packets stored in the received packet buffer to an order in accordance with the priority.

(Supplementary Note 17) A program for causing a computer to execute: a priority-related information storing step of storing transmission source information and destination information of a first packet in a header of the second packet which holds the first packet, and

a packet transmission step of transmitting the second packet which holds transmission source information and destination information of the first packet in a header.

(Supplementary Note 18) A program for causing a computer to execute: a packet reception step of receiving a packet; a priority acquisition step of obtaining a priority of the packet on the basis of transmission source information and destination information included in a packet received in the packet reception step;

a priority setting step of storing information indicating the priority in a header of the packet; and a packet transmission step of transmitting the packet which holds information indicating the priority in the header.

The present application claims priority based on Japanese Patent Application No. 2013-233041, filed on Nov. 11, 2013, the entire disclosure of which is incorporated herein.

### INDUSTRIAL APPLICABILITY

According to the present invention, more flexible priority setting is possible on a session in packet communication.

### REFERENCE SIGNS LIST

1, 2, 3 Packet communication system
11, 12 Transmission-side device
111 Packet generation unit
112 Packet transmission unit
123 Priority-related information storing unit
21, 22, 23 Reception-side device
210, 250 Packet reception unit
220, 260, 320 Storage unit
230, 240, 270, 330 Processing unit
221 Received packet buffer
222 Priority table storage unit
231, 241 Priority-related information acquisition unit
232 Packet arrangement order adjustment unit
233 Packet processing unit
234 Priority acquisition unit
33 Relay device
310 Packet transceiver unit
335 Priority setting unit

What is claimed is:

1) A device comprising:
a packet reception unit configured to receive a packet;
a received packet buffer configured to store a packet received by the packet reception unit;
a priority acquisition unit configured to obtain a priority of the packet based on transmission source information and destination information included in the packet received by the packet reception unit; and
a packet arrangement order adjustment unit configured to change an order of the packets stored in the received packet buffer to an order in accordance with the priority.

2) A device comprising:
a priority related information storing unit configured to store transmission source information and destination information of a first packet in a header of a second packet which stores the first packet; and
a packet transmission unit configured to transmit the second packet which holds transmission source information and destination information of the first packet in the header.

3) A device comprising:
a packet transceiver unit configured to transmit and receive a packet;
a priority acquisition unit configured to obtain a priority of a packet based on transmission source information and destination information included in the packet received by the packet transceiver unit; and
a priority setting unit configured to store information indicating the priority in a header of the packet,
wherein the packet transceiver unit transmits the packet which holds information indicating the priority in the header.

4) A session processing quality stabilization system comprising:
a transmission side device configured to transmit a packet; and a reception side device configured to receive the packet,
wherein the reception side device comprises:
a packet reception unit configured to receive the packet;
a received packet buffer configured to store a packet received by the packet reception unit;
a priority acquisition unit configured to obtain a priority of a packet based on transmission source information and destination information included in the packet received by the packet reception unit; and
a packet arrangement order adjustment unit configured to change an order of the packets stored in the received packet buffer to an order in accordance with the priority.

5) A session processing quality stabilization system comprising:
a transmission side device configured to transmit a packet;
a reception side device configured to receive the packet; and
a relay device configured to relay the packet from the transmission side device to the reception side device,
wherein the relay device comprises:
a packet transceiver unit configured to transmit and receives the packet;
a priority acquisition unit configured to obtain a priority of a packet based on transmission source information and destination information included in the packet received by the packet transceiver unit; and
a priority setting unit configured to store information indicating the priority in a header of the packet,
wherein the packet transceiver unit transmits the packet which holds information indicating the priority in the header, and
wherein the reception side device comprises:
a packet reception unit configured to receive the packet;
a received packet buffer configured to store a packet received by the packet reception unit; and
a packet arrangement order adjustment unit configured to change an order of the packets stored in the received packet buffer to an order in accordance with information indicating the priority stored in the header.

6) A priority processing method causing a device, comprising a packet reception unit configured to receive a packet and a received packet buffer configured to store a packet received by the packet reception unit, to execute:
obtaining a priority of the packet based on transmission source information and destination information included in a packet received by the packet reception unit; and
changing an order of the packets stored in the received packet buffer to an order in accordance with the priority.

7) A transmission method causing to execute:
storing transmission source information and destination information of a first packet in a header of a second packet which holds the first packet; and
transmitting the second packet which holds transmission source information and destination information of the first packet in the header.

8) A relay method causing to execute:
receiving a packet;
obtaining a priority of the packet based on transmission source information and destination information included in a received packet;
storing information indicating the priority in a header of the packet; and
transmitting the packet which holds information indicating the priority in a header.

9) (canceled)

10) (canceled)

11) The session processing quality stabilization system according to claim 4,
wherein the transmission side device transmits a second packet which holds a first packet, and
wherein the priority acquisition unit obtains a priority of the first packet based on transmission source information and destination information of the first packet included in the second packet.

12) The session processing quality stabilization system according to claim 11,
wherein the transmission side device includes:
a priority related information storing unit which stores transmission source information and destination information of a first packet in a header of a second packet which holds the first packet; and
a packet transmission unit which transmits the second packet including transmission source information and destination information of the first packet in a header,
wherein the packet reception unit receives the second packet transmitted by the packet transmission unit, the second packet including transmission source information and destination information of the first packet in a header, and
wherein the priority acquisition unit obtains a priority of the first packet based on transmission source information and destination information of the first packet stored in a header of the second packet which is received by the packet reception unit.

13) The session processing quality stabilization system according to claim 11,
wherein the received packet buffer stores the second packet and a priority of the second packet in association with each other, and
wherein the packet arrangement order adjustment unit rearranges the second packets stored in the received packet buffer in accordance with a priority associated with the second packet.

14) The session processing quality stabilization system according to claim 4,
wherein the reception side device further includes a priority table storage unit which stores a priority table indicating a correspondence relationship between a transmission source or a destination, and a priority, and
wherein the priority acquisition unit obtains a priority of the packet with reference to the priority table.
